(19) United States
(12) Patent Application Publication
(10) Pub. No.: US 2004/0199617 A1
(43) Pub. Date: Oct. 7, 2004

(54) Method and apparatus for facilitating maintenance

(76) Inventors: Ron Garrett, Poway, CA (US); Shane Tecklenburg, Westminster, CA (US)

Correspondence Address: MCDERMOTT, WILL & EMERY, 600 13th Street, N.W., Washington, DC, 20005-3096, US

(21) Appl. No.: 09/858,915

(22) Filed: May 17, 2001

Related U.S. Application Data
(60) Provisional application No. 60/204,777, filed on May 17, 2000.

(51) Int. Cl. G06F 15/16; G06F 15/173

(52) U.S. Cl. 709/223

(57) ABSTRACT

Audio/visual maintenance information relating to vehicle diagnostics is exchanged across a network. In operation, a customer, such as an automotive mechanic, can establish communication across a network, such as the internet or a telephone line, to a technician provided by a supplier of various goods and/or diagnostic equipment. Once the network connection is established, the customer can describe symptoms and vehicle type to the technician. In response, the technician can provide both verbal and visual information to the customer. The visual information can include streamed-video images, electrical and mechanical diagrams, drawings produced by the technician, various electronic waveforms measurable by an oscilloscope and the like. By using a combination of visual information to supplement verbal descriptions and instructions, the customer can more easily and quickly comprehend information provided by the technician.

### CROSS REFERENCE TO RELATED APPLICATIONS

This non-provisional application claims the benefit of U.S. Patent Provisional Application No. 60/204,777 (Attorney Docket No. 10473-677) entitled “Vehicle Diagnostics” filed on May 17, 2000. The above-provisional application is hereby incorporated by reference in its entirety including all references cited therein.

### FIELD OF THE INVENTION

This invention relates to methods and systems for facilitating maintenance operations using audio/visual information provided over a network.

### DESCRIPTION OF RELATED ART

As each major consumer product becomes increasingly complex, the difficulty to maintain and repair such products can increase commensurately. As a result, even simple maintenance or repair operations can require highly skilled technicians/mechanics that must use sophisticated diagnostic equipment. While diagnostic equipment can be inexpensively provided to the market place, providing trained and competent technicians/mechanics that can use the diagnostic equipment to service complex products can be incredibly expensive.

One approach to alleviating such expense is to provide “technical help hotlines”. These “hotlines” can consist of a number of knowledgeable technicians employed by a particular vendor of either the product to be maintained or of the diagnostic equipment. In operation, a customer, such as an automobile mechanic, using a particular diagnostic tool could make a telephone call to the hotline. The customer could then explain his particular problems to a technician and the technician subsequently could provide advice to the customer. Unfortunately, such conventional hotlines can be difficult and cumbersome to work with, especially when a customer requires visual information, as opposed to just verbal descriptions of visual information. That is, because certain information, such as a complex electronic waveform, is not readily conveyed by verbal descriptions, it may be difficult for a technician to advise or otherwise help a particular customer. Accordingly, new apparatus and methods that can more effectively provide maintenance information to customers are needed.

### SUMMARY OF THE INVENTION

The present disclosure relates to methods and systems for providing audio/visual maintenance and repair information across a network. In operation, a customer can activate a software package on a terminal, such as a personal computer, that can make a connection across a network, such as the internet or a telephone line, to a technician provided by a supplier of various goods and/or diagnostic equipment. Once established, the customer can explain his various problems to the technician. In response, the technician can provide both audio and visual information to the customer.

In various embodiments, the visual information can include streamed-video images, electrical and mechanical diagrams, drawings produced by the technician and comparative diagnostic images, such as examples of various known waveforms produced by a given electronic circuit. By using a combination of visual information to supplement verbal descriptions and instructions, the customer can more easily and quickly comprehend information provided by the technician. Others features and advantages will become apparent in the following descriptions and accompanying figures.

### BRIEF DESCRIPTION OF THE DRAWINGS

References are made to the attached drawings, wherein elements having the same reference numeral designations represent like elements throughout, and wherein:

FIG. 1 is a block diagram of a networked audio/visual maintenance system;

FIG. 2 is a block diagram of the service terminal of FIG. 1;

FIG. 3 is a block diagram of the customer terminal of FIG. 1;

FIG. 4 depicts the customer terminal of FIG. 1 having a visual whiteboard;

FIG. 5 depicts a complex measured waveform and a comparative diagnostic waveform; and

FIG. 6 is a flowchart outlining an exemplary operation directed to providing audio/visual maintenance information over a network.

### DETAILED DESCRIPTION OF ILLUSTRATIVE EMBODIMENTS

While various “technical help hotlines” can provide customers valued assistance such that the customer can perform various maintenance and repair operations, conventional hotlines suffer from a number of problems. That is, because conventional hotline operations are conducted over the telephone, these conventional hotlines are generally limited to verbal exchanges between a technician servicing the hotline and a customer. As a result, it can be very difficult to convey valuable information from a technician to the customer.

For example, a mechanic servicing an automobile may be required to hook up a number of oscilloscope probes to various points on an electronic board associated with the automobile. If the particular electronic circuits at issue are complex, finding particular diagnostic points can be difficult if the only reference available is a verbal description from a technician over a telephone. However, these same diagnostic points can otherwise quickly be found if the technician first provides a visual diagram to accompany his verbal description.

By way of further example, assuming that the automobile mechanic has properly placed the oscilloscope probes, properly configured the oscilloscope, and taken the appropriate electronic measurements, the mechanic may then require assistance in interpreting the electronic measurements. Again, because oscilloscope displays are primarily visual in nature, it can be difficult for a service technician to convey the proper information to the mechanic using only verbal descriptions. However, by providing a number of comparative images of electronic waveforms to the mechanic, the mechanic can more easily interpret the oscilloscope measurements.

In addition to simple diagrams and waveforms, other visual cues can also be helpful. For example, to aid the mechanic in a particular procedure, the technician can provide a streamed-video image, i.e., a motion picture type-display, either from a streamed-video database or by using a camera accessible to the technician. While various audio/visual presentations, such as high-resolution streamed-video presentations, can often require excessive amounts of bandwidth across a particular network that may not be available, it should be appreciated a versatile combination of still diagrams, low-resolution streamed-video images, pictures of electrical waveforms or any other useful form of visual information may provide an ideal combination of information to accompany the technician's verbal instructions depending on the particular circumstances. Accordingly, by providing a service technician the capacity to append a variety of visual information onto a clipboard/whiteboard that can be shared with a customer, maintenance and repair of extremely complex systems using extremely complex tools can be inexpensively facilitated.

In view of the following disclosure, it should be appreciated that the term “maintenance” can refer to any of a variety of operations on various tangible devices, such as an automobiles or electronic circuits, including performing various measurements and repair operations. Conversely, it should be appreciated that the term “maintenance” does not apply to performing operations related to various intangibles, such as updating various business practices, assessing the effectiveness of a particular policy, providing sales information and the like.

It should further be appreciated that the term “audio information” can refer to any information in any form that can be perceived, or processed to be perceived, to the human ear as recognizable sound, including sounds produced by electronic systems, mechanical systems and humans. It should also be appreciated that the term “verbal information” is to be expressly limited to any information in any form that can be perceived, or processed to be perceived, to the human ear as intelligible human speech and that is produced by a technician or a customer.

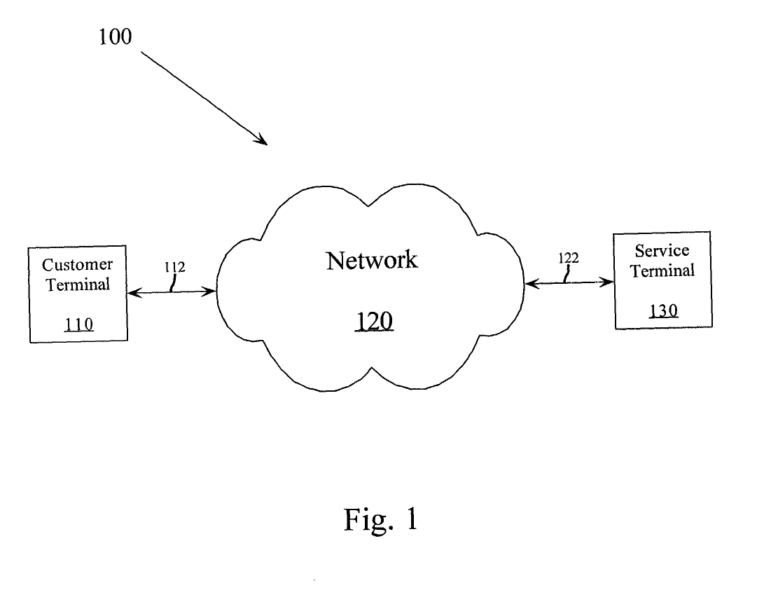

FIG. 1 is a block diagram of a networked maintenance system 100 capable of providing a customer with audio/visual maintenance information. As shown in FIG. 1, the maintenance system 100 includes a network 120 connected to a customer terminal 110 via link 112, and further connected to a service terminal 130 via link 122. In operation, a customer, such as an automobile mechanic, can activate a software program provided by a particular vendor that can establish a communication link to the vendor. Once activated, the vendor software can facilitate two-way communication between the customer terminal 110 and the service terminal 130 via the network 120 and links 112 and 122. Additionally, the activated software can configure the customer terminal 110 to perform various other tasks, such as configuring various peripherals associated with the customer terminal 110 to provide a variety of interfaces between the customer terminal 110 and a customer such that the interfaces can convert text, audio and visual information into electronic signals, and further such that the interfaces can convert various electronic signals into text, audio and visual information.

For example, a customer using the customer terminal 110 can type various messages into the customer terminal 110 using a keyboard that can be relayed to the service terminal 130. Furthermore, the customer terminal 110 can receive various audio information from the customer, such as the customer's voice, and relay this audio information to the service terminal 130.

Similarly, a technician using the service terminal 130 can type various messages into the service terminal 130 that can be relayed to the customer terminal 110. Furthermore, as with the customer terminal 110, the service terminal 130 can receive various audio information, such as the technician's voice and any other sound-based signals, and relay this audio information to the customer terminal 110.

In various embodiments, in addition to text and audio information, the customer terminal 110 and the service terminal 130 can transmit and receive visual image information to one another. For example, a technician situated at the service terminal 130 can access various images, such as wiring diagrams, electrical diagrams, mechanical diagrams and the like from a database associated with the service terminal 130 and append the various image information onto an electronic clipboard. The appended information can then be electronically transferred and displayed at a display associated with the customer terminal 110.

Once displayed, a customer can view the various images on the clipboard. In this fashion, a customer can gain information that is more naturally conveyed in visual form, as opposed to information that is more easily gained in audio form. As discussed above, the form of the images received and displayed can be mixed and widely varied. For example, a first received image can be a simple JPEG image of a wiring diagram, while a second image can be a GIF image having a number of frames to give the illusion of motion while a third image can consist of a streamed-video image.

During operation, it should be appreciated that the various images provided to the customer can be provided from a number of sources. For example, images can be provided from a database residing at the technician's terminal 130, from various other databases accessible through the network 120, contemporaneously created by the technician using a drawing package and a graphic interface that allows the technician to hand-draw various figures on the fly or any other viable source of image information.

In various embodiments, it should be appreciated that an electronic clipboard can take the form of a “whiteboard”. A whiteboard, like a clipboard, can be graphic tool that allows the technician to post various images on an electronic display. However, unlike a clipboard, a whiteboard can allow multiple parties to post and manipulate electronic images. For example, assuming a technician posts a schematic diagram of an electronic circuit for a customer to view, the customer may take various measurements at various points along an electronic circuit represented by the schematic diagram and append various information to the schematic diagram, such as voltage levels and/or depictions of observed waveforms. The information posted by the customer can then be transmitted back to the service terminal 130 over the network 120 and displayed to the technician for the technician's review and analysis.

During operation, a customer may desire to analyze complex visual information provided by any of various diagnostic tools, such as oscilloscopes, digital multi-meters, specialized automotive diagnostic tools, electromagnetic interference measuring devices, spectrum analyzers, specialized telecommunication test and development equipment, X-ray equipment, ultra-sonic and magneto-resonant imaging equipment and the like. Because such diagnostic equipment can produce visual information containing a vast amount of visual nuance that can be difficult to describe or otherwise require special nomenclature to describe, it should be appreciated that a customer could benefit from image information, rather than verbal descriptions.

To address this need, the technician can provide various comparative diagnostic information to a customer such that the customer could compare the supplied comparative diagnostic information to measured information taken from various diagnostic equipment. For example, a customer debugging a wireless television transmitter may need to capture a frame of video data and compare the captured video data frame to various video frame samples provided by the technician, which can include a perfectly functional video frame waveform as well as a number of video frame waveforms known to occur during known failure conditions.

After viewing the comparative diagnostic images, the customer cam provide feedback to the technician by discussing the situation with the technician or providing various images back to the technician. The customer can then take a decision as to which comparative diagnostic image, if any, best resembles the measured image and act accordingly.

As discussed above, another option available to a customer can be to receive various streamed video images. For example, a customer wishing to learn to adjust the timing of an automobile engine may need to use a special tool at a special location in a special fashion. By enabling a technician to provide streaming video images of himself going through the required motions on a mock-up engine or otherwise provide images from a stored database of streamed video images, such as a database of .MOV files, a customer can study the required motions and effects of timing adjustment and act accordingly.

The exemplary network 120 can be a portion of the Internet. However, in various embodiments, the network 120 can be any known or later developed combination of systems and devices capable of conducting information between two terminals such as a public switch telephone network (PSTN), a local area network, a wide area network, an intranet, the Internet, portions of a wireless network, and the like. Similarly, the exemplary links 112 and 122 can be electronic systems running transmission control protocol/Internet protocol (TCP/IP) on the Internet. However, in various embodiments, the exemplary links 112 and 122 can be any known or later developed combination of systems and devices capable of facilitating communication between the network 120 and the terminals 110 and 130, such RS-232 links, 10baseT links, 100baseT links, ethernet links, optical-based links, wireless links, sonic links and the like.

The terminals 110 and 130 can be personal computers having a variety of peripherals capable of communicating with the network 120 and further transforming various physical signals, such as visual, audio and tactile information into electronic form, while similarly transforming various received electronic signals into appropriate physical signals. However, in various embodiments, either of the exemplary terminals 110 and 130 can be variants of personal computers, servers, personal digital assistants (PDAs), conventional or cellular phones with graphic displays or any other known or later developed devices that can communicate with the network 120 over respective links 112 and 122 and transform various physical signals into electronic form, while similarly transforming various received electronic signals into physical form.

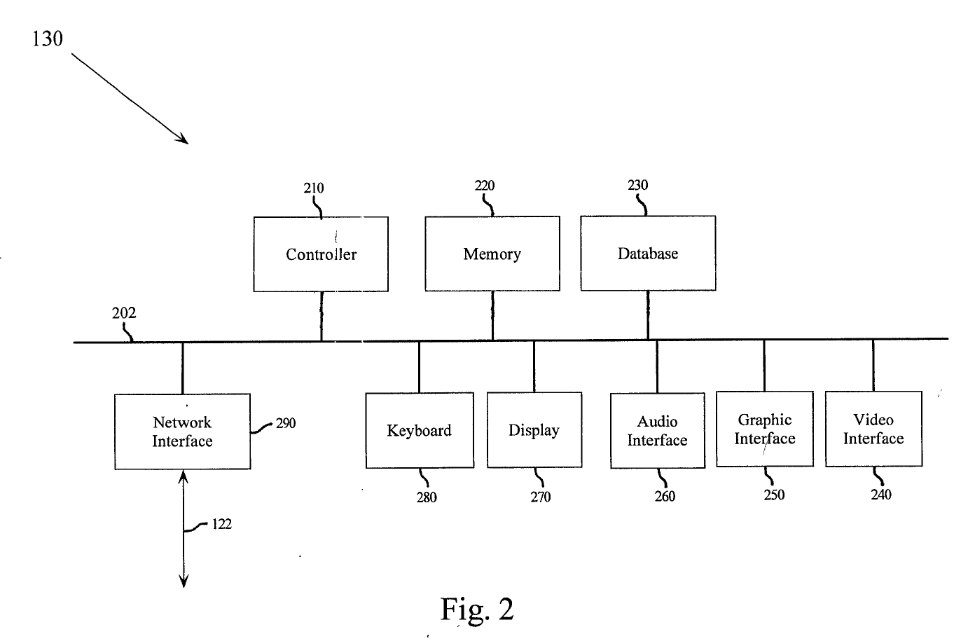

FIG. 2 is a block diagram of the service terminal 130 of FIG. 1. As shown in FIG. 2, the service terminal 130 includes a controller 210, a memory 220, a database 230, a video interface 240, a graphic interface 250, an audio interface 260, a display 270, a keyboard 280, and a network interface 290. The above components are coupled together using a control/data bus 202. Although the exemplary service terminal 130 uses a bussed architecture, it should be appreciated that the functions of the various components 210-290 can be realized using any number of architectures, such as architectures based on dedicated electronic circuits and the like.

In operation and under control of the controller 210, the network interface 290 can receive a maintenance request from a customer over a network (not shown) and link 122. Once the maintenance request is received, the controller 210 can notify a technician (also not shown) of the pending maintenance request via the display 270. Using the keyboard 280, the technician can acknowledge the maintenance request and establish a two-way communication with the requesting customer using the network interface 290.

The exemplary network interface 290 is a modem connected to the Internet. However, in various embodiments, the network interface 290 can be an interface to any known or later developed communication network according to any known or later developed protocol, such as an RS-232 interface, a 10baseT interface, a 100baseT interface, an ethernet interface and the like.

As discussed above the various communications between a technician and a customer can take a variety of forms, such as text, audio information and image information. Accordingly, as the controller 210 receives information from the customer, the controller 210 can temporarily store the information in the memory 220, distinguish the form of information and react appropriately.

For example, upon receiving audio information the controller 210 can provide the received audio information to the audio interface 260. The audio interface 260, in turn, can provide any requisite processing to convert the audio information from electronic form to mechanical form or any other form capable of being perceived by a person.

Similarly, the audio interface 260 can receive audio information, such as speech signals from the technician, convert the speech signals into electronic form and provide the converted signals to the controller 210. The controller 210, in turn, can package the information in a form readily transmitted over a network, and provide the package audio information to the customer by the network interface 290.

As with audio information, any image information received by the service terminal 130 via the network interface 290 can be provided to the display 270. Also, in order to facilitate maintenance, that a wide variety of image information can be useful to a customer. Accordingly, a technician attending the service terminal 130 can use the variety of devices to derive image information.

For example, as discussed above, a technician, using the keyboard 280 and/or computer mouse (not shown), can access various image information from the database 230 and post the image information onto a clipboard or whiteboard that in turn can be provided to a customer. Still further, the video interface 240 can provide a streamed-video image, i.e., a sequence of images that appears or approximately appears as contiguous motion. However, in other embodiments, it should be appreciated that a streamed-video image can include video images captured and provided to a client on a roughly periodic basis. For example, it can be useful to provide a customer with a video feed that updates an image scene every second.

Returning to FIG. 2, it should also be appreciated that a technician can use the graphic interface 250 to hand-draw various images, such as crude schematics and/or waveforms or the technician may create graphic images on the fly using a drawing package and a mouse, which can be appended to a clipboard/whiteboard and subsequently provided to a customer. Also as discussed above, as image information can be derived from sources other than the service terminal 130, it should be appreciated that a technician can retrieve various images from external databases via the network interface 290. Once retrieved, the externally supplied image information can be appended to the clipboard/whiteboard and again provided to the customer.

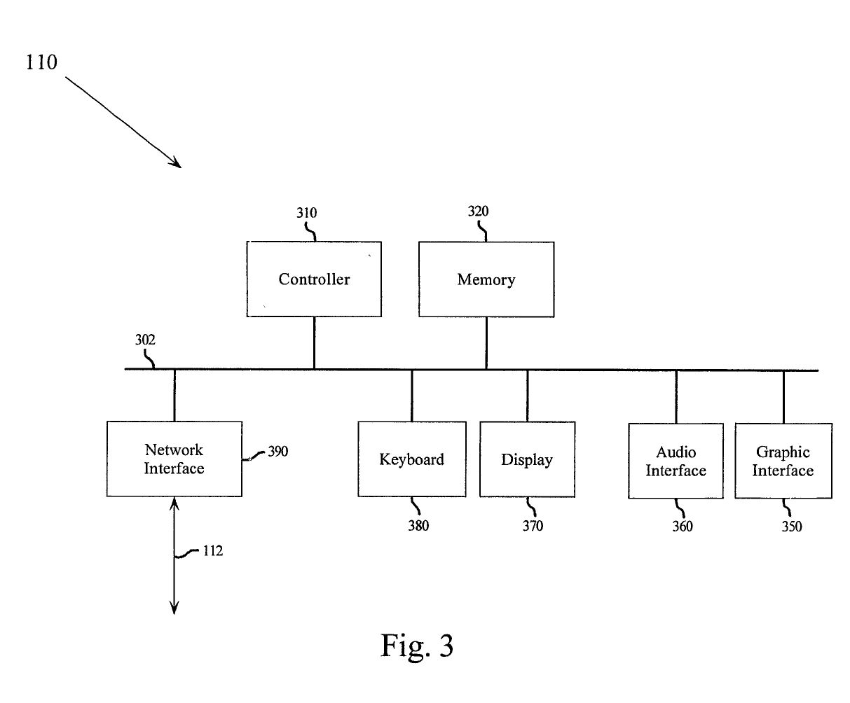

FIG. 3 is a block diagram of the exemplary customer terminal 110 of FIG. 1. As shown in FIG. 3, the customer terminal 110 includes a controller 310, a memory 320, a graphic interface 350, an audio interface 360, a display 370, a keyboard 380, and a network interface 390. The above components 310-390 are coupled together using a control/data bus 302. Although the exemplary customer terminal 110, like the service terminal 130, uses a bussed architecture, it should again be appreciated that the functions of the various components 310-390 can be realized using any number of architectures, such as architectures based on dedicated electronic and optic hardware and the like. It should also be appreciated that the various components 310-390, can operate in manners substantially similar to their counterparts 210-290 found in the service terminal 130. Still further, it should be appreciate that for reasons of economy, various components such as the graphic interface 350 can be eliminated or replaced using various other tools, such as a drawing package and mouse.

In operation, a customer using a keyboard 380 can activate a software program located in the memory 320 that can cause the controller 310 to configure the displays 370, the audio interface 360 and graphic interface 350 as well as establish a network connection with a service terminal (not shown) using the network interface 390 and link 112. Once the network connection is established, the customer can speak with and as listen to a service technician using the audio interface 360, which can contain both a speaker and microphone (not shown). In addition to receiving verbal information from a technician, as discussed above, the technician can provide a number of different useful types of audio information stored at various sources. For example, it can be useful for an automobile mechanic to listen to a variety of automobile engine sounds related to various known and documented engine ailments. For example, an automobile engine that is misfiring on a particular cylinder may produce a distinctly different sound than an automobile engine that is misfiring on another cylinder. A customer, hearing the different sounds may readily identify the particular cylinder that is misfiring based on the provided audio information.

Also, as discussed above, the customer can receive various schematic diagrams of an electronic system as well as instructions on how to use a particular tool, such as an oscilloscope. Using the provided schematic as well other visual cues provided by service technician, the customer can appropriately configure the oscilloscope and measure various electronic nodes associated with a particular electronic circuit.

Once the customer has measured the appropriate electronic nodes, it should be appreciated that the customer may require further assistance from a service technician in evaluating or otherwise analyzing the measured information. For example, various electronic circuits, such as cathode ray tube (CRT) and liquid crystal display (LCD) drivers produce very complex waveforms having various periodic components. As subtle defects in a particular electronic circuit can produce subtle distortions in electronic waveform that could otherwise have noticeable effects on the quality of a display, it should be appreciated that the customer may require visual comparative diagnostic information, as opposed to mere verbal descriptions, to diagnose the electronic circuit.

Accordingly, in response to the customer's request, a service technician can provide a number of comparative electronic waveforms as well as any other comparative diagnostic image information that can assist the customer in diagnosing, maintaining or repairing the drive circuit.

During operation, the audio/visual communication between the customer and the service technician can continue as required with the service technician providing various image information while at the same time providing vocal instruction until the customer's maintenance needs are fulfilled or the maintenance session is otherwise terminated. It should be appreciated that all of the various information acquired by the customer can be selectively or entirely catalogued and stored in the memory 220. Accordingly, the customer can retrieve and review the information at any time in the future.

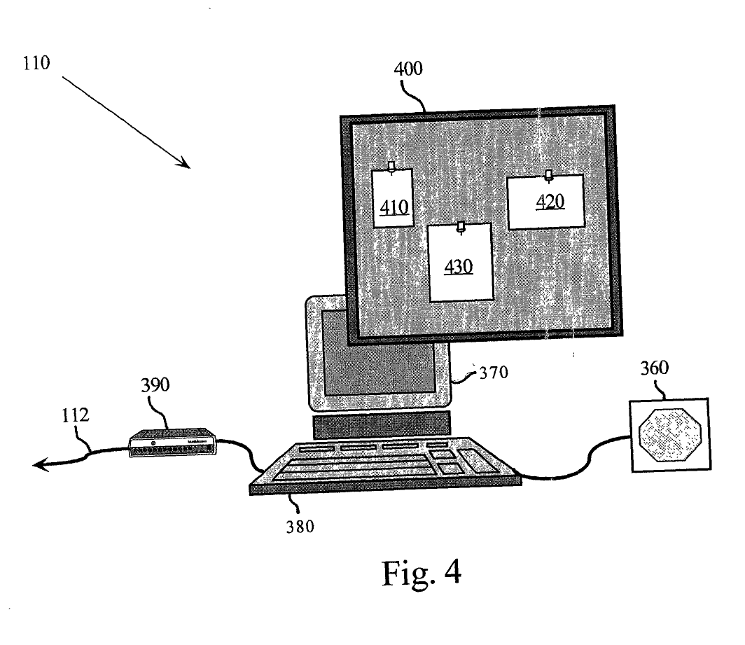

FIG. 4 is a second diagram depicting the customer terminal 110 of FIG. 1. As shown in FIG. 4, an electronic whiteboard 400 can be embedded into the display 370. Also shown in FIG. 4, the whiteboard 400 contains three images 410, 420 and 430. As discussed above, the various images 410-430 can be any one of a variety of image information types such as a mechanical or electrical diagram, streamed-video information, or comparative diagnostic information, such as various waveforms produced by various electronic circuits.

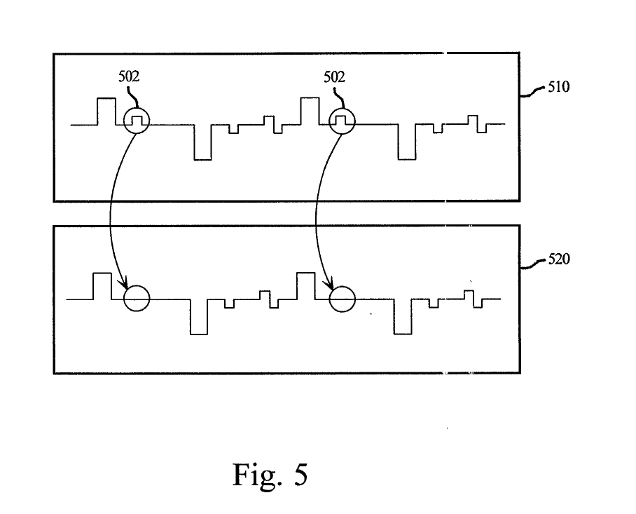

FIG. 5 depicts an exemplary measured electronic drive signal 520 produced by a liquid crystal drive circuit along with and a comparative electronic drive signal 510 produced by a liquid crystal drive circuit. As shown in FIG. 5, the signals 510 and 520 are complex waveforms and would be very difficult for a technician to verbally describe to a customer. However, as shown in FIG. 5, the good (comparative) electronic signal 510 contains a periodic feature 502 not found in the defective (measured) signal 520. As discussed above, by providing visual comparative information, such as the good signal 510, accompanied by a technician's verbal instructions and descriptions, a customer can readily diagnose the measured waveform 520 as defective. Also as discussed above, in addition to a good waveform, a technician can provide a number of defective waveforms associated with various known problems such that a customer can diagnose a particular problem based on the provided waveforms.

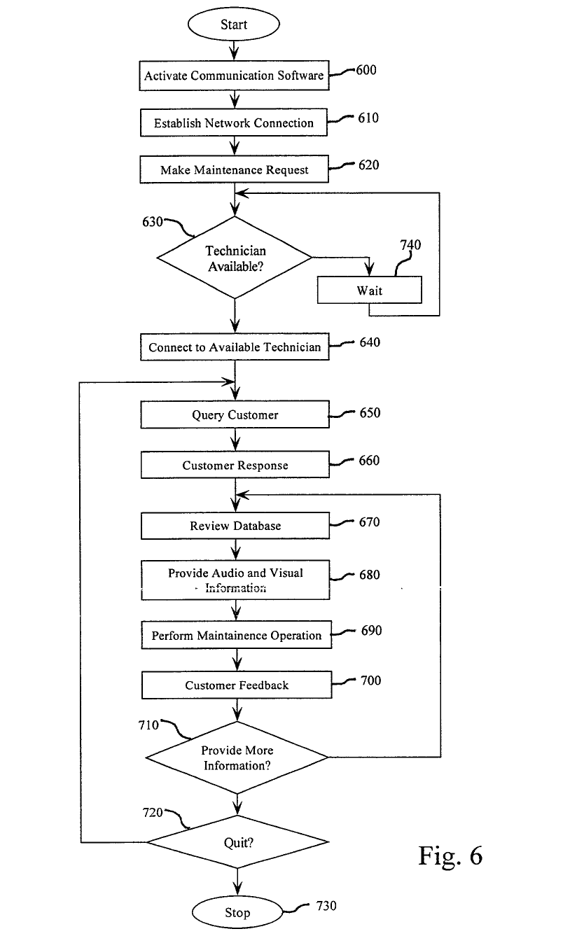

FIG. 6 is a flowchart outlining an exemplary operation of a method for facilitating maintenance over a network. The process starts at step 600 where a customer located at a customer terminal can activate a communications software package that can configure various peripherals located at the customer terminal as well as attempt to establish a network connection to a technician located at a service terminal. Next, in step 610, a network connection is established. Then, in step 620, a maintenance request is made by the customer terminal to the service terminal. The process continues to step 630.

In step 630, a determination is made as to whether a technician is available to service the requesting customer. If a technician is available, control continues to step 640; otherwise, control jumps to step 740. In step 740, the customer is requested to wait until a service technician is available and control jumps back to step 630 where another determination is made as to the availability of a service technician.

In step 640, the customer is connected to an available technician. Next, at step 650, the technician can request various information from the customer as to the nature of the customer's maintenance issues. Then, in step 650, the customer can appropriately respond to the technician's query, thus informing the technician of the customer's maintenance issues. Control continues to step 670.

In step 670, the technician can review a database and/or draw from any available manuals and experience to perform an initial diagnosis of a customer's problem. Next, in step 680, the technician can provide audio and visual information to the client. As discussed above, the various audio information can include verbal instructions and descriptions from the technician, as well as various other audio information useful to a customer. Furthermore, as discussed above, the visual information can include various images, such as electrical and mechanical diagrams, streamed-video information, and comparative diagnostic information, such as various electronic waveforms, figures of various mechanical and electrical systems that have undergone various known an documented failures or any other image information useful by a customer to diagnose a maintenance problem by viewing and comparing the image to various measured or otherwise observed information. Control continues to step 690.

In step 690, the customer can perform a maintenance operation based on the information or other instructions provided at step 680. The maintenance operation can include such actions such as manipulating a system to be maintained, repairing the system using any number of various tools and measuring various electrical and/or mechanical states of the system using any available diagnostic equipment. Control continues to step 700.

In step 700, the customer can provide feedback to the technician. As discussed above, the customer feedback can include verbal descriptions, other audio information, visual information via a whiteboard and appropriate graphic tools and the like. Next, at step 710, a determination is made as to whether the technician needs to provide more information to the customer. If more information is to provided, control jumps back to step 670; otherwise, control continues to step 720.

At step 720, another determination is made as to whether to terminate the maintenance session. If the maintenance session is to terminate, control continues to step 730 where the process stops; otherwise, control jumps back to step 650 where the technician can make another query of the customer. The maintenance session can continue until the technician has provided all the assistance that the customer requires or circumstances otherwise require the maintenance session to end. As discussed above, it should be appreciated that all of the various information acquired by the customer can be selectively or entirely catalogued and stored in the memory 220. Accordingly, even after the maintenance session has ended, the customer can retrieve and review the information at his convenience.

The foregoing description of the various embodiments have been presented for purposes of illustration and description. It is not intended to be exhaustive or to limit the invention to the precise form disclosed, and modifications and variations are possible in light of the above teachings or may be acquired from practice of the invention. The embodiments were chosen or described in order to explain the principles of the invention and enable one of ordinary skill in the art to utilize the systems with various modifications as would be suited to a particular use as contemplated. It is intended that the scope of the various embodiments be defined by the claims appended hereto, and their equivalence.

What is claimed is:

1. A method for facilitating a maintenance operation over a network, comprising:
receiving a maintenance request directed to the maintenance operation from a customer over the network; and
providing information directed to performing the maintenance operation to the customer over the network in response to the maintenance request, wherein the provided information includes at least contemporary verbal and visual information.

2. The method of claim 1, wherein the visual information is displayed at a terminal associated with the customer.

3. The method of claim 1, wherein the network includes at least one of the Internet and a public switched telephone network.

4. The method of claim 1, wherein the visual information includes one or more images.

5. The method of claim 1, wherein at least a portion of the visual information is not streamed-video information.

6. The method of claim 4, wherein at least one image is an electrical diagram or a mechanical diagram.

7. The method of claim 4, wherein the visual information includes information directed to a repair procedure.

8. The method of claim 6, wherein at least a portion one of the information is directed to operating a tool used in the maintenance operation.

9. The method of claim 8, wherein the tool is a diagnostic tool.

10. The method of claim 9, further comprising receiving diagnostic information from the customer, wherein the received diagnostic information is provided using the diagnostic tool.

11. The method of claim 9, further comprising providing visual comparative information to the customer such that the customer can compare the visual comparative information to diagnostic information provided using the diagnostic tool.

12. The method of claim 8, wherein the network includes at least one of the Internet and a public switched telephone network.

13. The method of claim 6, further comprising providing visual feedback from the customer to the technician.

14. An apparatus for facilitating a maintenance operation over a network, comprising:
a network interface that receives a maintenance request from a customer over the network, wherein the maintenance request is directed to the maintenance operation; and
a terminal that provides information to the customer over the network in response to the maintenance request, wherein the provided information includes at least contemporary verbal and visual information directed to performing the maintenance operation.

15. The apparatus of claim 14, wherein the visual information is displayed at a terminal associated with the customer.

16. The apparatus of claim 14, wherein the terminal includes a database that contains at least a portion of the visual information.

17. The apparatus of claim 14, wherein the network includes at least one of the Internet and a public switched telephone network.

18. The apparatus of claim 14, wherein at least a portion of the visual information is not streamed-video information.

19. The apparatus of claim 16, wherein the database further includes maintenance instructions directed to a tool.

20. The apparatus of claim 19, wherein the tool is a diagnostic tool.

21. The apparatus of claim 20, wherein the database further includes visual comparative information, and wherein the visual comparative information is provided to the customer over the network such that the customer can compare the visual comparative information to information provided using the diagnostic tool.

22. The apparatus of claim 16, wherein the visual information includes one of an electrical diagram and a mechanical diagram.

23. The apparatus of claim 16, further comprising a graphic interface configured such that a technician can create images, and wherein the created images are provided to the customer over the network.

24. The apparatus of claim 19, wherein the network interface further receives diagnostic information from the customer, wherein the received diagnostic information is provided using the diagnostic tool.

25. The apparatus of claim 19, wherein the network interface further receives visual feedback from the customer.

26. An apparatus for facilitating a maintenance operation over a network, comprising:
a network interface that transmits a maintenance request to a technician over the network, wherein the maintenance request is directed to the maintenance operation; and
a terminal that receives information from the technician in response to the maintenance request over the network; and
wherein the received information includes at least contemporary verbal and visual information directed to performing the maintenance operation;
wherein the terminal includes a display and the visual information includes at least one image that is displayed using the display.

27. The apparatus of claim 26, wherein the network includes at least one of the Internet and a public switched telephone network.

28. The apparatus of claim 26, wherein the visual information includes at least one of visual comparative information and a diagram.

29. The apparatus of claim 26, wherein at least a portion of the visual information is not streamed-video information.

30. The apparatus of claim 26, wherein the network interface further transmits visual feedback to the technician.

31. A method for facilitating a maintenance operation over a network, comprising:
first conducting over the network a maintenance request directed to the maintenance operation from a customer to a technician; and
second conducting over the network information directed to performing the maintenance operation from the technician to the customer over the network in response to the maintenance request, wherein the provided information includes at least contemporary verbal and visual information.

32. The method of claim 31, wherein at least a portion of the visual information is not streamed-video information.

33. The method of claim 31, wherein the network includes at least one of the Internet and a public switched telephone network.

34. The apparatus of claim 31, further comprising conducting visual feedback from the customer to the technician.
